(19) United States
(12) Patent Application Publication
(10) Pub. No.: US 2005/0279766 A1
(43) Pub. Date: Dec. 22, 2005

(54) Dispensing system and method of use

(76) Inventor: Thomas F. Wiegner, St. Charles, IL (US)

Correspondence Address: Lesavich High-Tech Law Group, P.C., Suite 325, 39 S. LaSalle Street, Chicago, IL, 60603, US

(21) Appl. No.: 11/145,330

(22) Filed: Jun. 3, 2005

Related U.S. Application Data
(60) Provisional application No. 60/576,931, filed on Jun. 4, 2004.

(51) Int. Cl. B67D 5/38

(52) U.S. Cl. 222/158; 222/216

(57) ABSTRACT

A dispensing system and method of use. The dispensing system includes a freshness preserver plate that allows goods in ground, powder or granular form (e.g., coffee, flour, spices, sugar, salt, laundry detergent, plant fertilizer, etc.) to be easily dispensed, accurately measured and kept fresh with an airtight seal created by the freshness preserver plate during the dispensing process. The shape of the freshness preserver plate also helps dispense the goods while keeping contact of the goods with air outside the dispensing system to a minimum.

### CROSS REFERENCES TO RELATED APPLICAITONS

The application claims priority to U.S. Provisional Application 60/576,931 filed on Jun. 4, 2004, the contents of which are incorporated by reference.

### FIELD OF THE INVENTION

This invention relates to dispensing systems. More specifically, it relates to a dispensing system and method of use for coffee, spices and other goods in ground, powder or granular form.

### BACKGROUND OF THE INVENTION

There are many types of goods used in a kitchen that need to be dispensed on a regular basis. For example, coffee, flour, spices, etc. and other goods are used on a daily basis. There are several problems associated with dispensing such goods. One problem is that dispensing systems known in the art tend to frequently become clogged based on the characteristics of the goods they are dispensing and the design of the dispensing system. Another problem is that such dispensing systems do not provide the ability to accurately or precisely dispense a desired amount of the goods.

Another problem is that most dispensing systems are not airtight and thus they do not maintain the freshness of the goods they are dispensing and also allow the goods to come into contact with air. In addition, a well-known coffee company offers a re-sealable plastic container with a screw or snap top that can be used to dispense coffee. However, this type dispenser when used with coffee would not provide for a freshness barrier because new air is allowed to enter the headspace above the coffee every time the container is opened and coffee is dispensed from the container by scooping or poring it out. This “new air” (oxygen) depletes the coffee's freshness (oxidizes the oils)(e.g., an aroma) incrementally leading to consumer dissatisfaction.

Another problem is that lack of an airtight seal also allows the goods to absorb water or other types of moisture. When the goods absorb water, they typically become sticky and/or lumpy and more difficult to dispense. Another problem is that many dispensing systems known include complicated components that are subject to mechanical failures and breakdowns. Another problem is that many dispensing systems known in the art have internal funnel systems that are also subject to clogging or mechanical breakdowns.

There have been attempts to solve some of the problems associated with dispensing systems. For example, U.S. Pat. No. 4,155,486, entitled “Rotary Feeder” that issued to Brown, now expired, teaches a rotary feeder has a valvular rotor rotating on an axis in a cylindrical cavity. A plurality of rigid, free-floating blades project from a hub of the rotor to delimit several material-receiving pockets circumferentially distributed over the hub. The inner edges of the blades rest in axial recesses in the hub and are supported by fixed projections extending outwardly from the hub along the trailing side of the blades. The recesses permits limited angular movement of the blades relative to the hub. The blades have widths from the hub to the periphery of the cylindrical cavity greater than corresponding radii through the inner edges of the blades at the hub, whereby the blades are angularly inclined relative to such radii. Top portions of the blades are applied to peripheral wall portions of the cylindrical cavity. The recesses, the fixed projections, and peripheral wall portions of the cylindrical cavity cooperate to hold the blades in position. The fixed projections carry means for urging the blades toward the corresponding radii. The blades are biased or periodically adjusted angularly toward the mentioned corresponding radii during wear of the outer portions and the peripheral wall portions to maintain worn top portions of the blades applied to the peripheral wall portions of the cylindrical cavity.

U.S. Pat. No. 4,511,067, entitled “Particulate matter dispensing device” that issued to Martin, et al., now expired, teaches a particulate material dispenser comprising an elongate, vertically extending body defining an upwardly opening material holding compartment, an elongate, laterally extending semi-cylindrical chamber at the bottom of the body and opening upwardly into the compartment and an elongate, laterally extending vertical discharge opening with front, rear and end edges at the bottom of said chamber, an elongate rotor with a plurality of circumferentially spaced, longitudinally extending, radially outwardly projecting webs with outside edges and defining a plurality of circumferentially spaced radially outwardly opening material receiving and transporting pockets of predetermined volume, is positioned in and extends longitudinally of the chamber with the outside edges of two adjacent webs at the lower half of the rotor in sliding sealing engagement with the inside surface of the chamber adjacent the front and rear edges of the opening and with the pocket there between communicating with the opening, a spring is positioned in the compartment above the rotor to normally yieldingly urge the rotor down in the chamber, a drive is provided to intermittently move the spring, turn the rotor and sequentially advance the pockets into and out of communication with the opening.

U.S. Pat. No. 4,893,737, entitled “Dispensing apparatus” that issued to Borjesson, now expired, teaches a dispenser for goods such as coffee has a container with a discharge opening in its bottom, a rotor which covers the bottom of the container and is provided with vanes which define a plurality of dispensing compartments, and a wiper which covers the rotor in the vicinity of the discharge opening. A drive mechanism with a stepwise pivoting action is operable to move one dispensing compartment at a time to the discharge opening. The lower surface of each vane has a leading edge which contacts the container bottom, and there is a rake space between this lower surface and the bottom of the container. The wiper extends up to intersect the container wall at an acute angle to prevent the goods from rotating with the rotor.

However, these inventions still do not solve all of the problems associated with dispensing systems. It is desirable to provide a dispensing system for such goods that allow them to be easily dispensed, accurately measured and keeps the goods fresh during the dispensing process.

### SUMMARY OF THE INVENTION

In accordance with preferred embodiments of the present invention, some of the problems associated with dispensing systems are overcome. A dispensing system and method of use is presented.

The dispensing system includes a freshness preserver plate that allows goods in ground, powder or granular form (e.g., coffee, flour, spices, sugar, salt, laundry detergent, fertilizer, etc.) to be easily dispensed, accurately measured and kept fresh with an airtight seal created by the freshness preserver plate during the dispensing process. The shape of the freshness preserver plate also helps dispense the goods while keeping contact of the goods with air outside the dispensing system to a minimum.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating a perspective view of components of a dispensing system;

FIG. 2 is a block diagram illustrating an exploded view of the dispensing system;

FIG. 3 is a block diagram illustrating a side view of the dispensing system;

FIG. 4 is a block diagram illustrating a top view of a freshness preserver plate of the dispensing system;

FIG. 5 is a flow diagram illustrating a method of use of the dispensing system;

FIG. 6 is a block diagram visually illustrating use of the dispensing system; and

FIG. 7 is a block diagram illustrating another exploded view of the dispensing system.

### DETAILED DESCRIPTION OF THE INVENTION

Exemplary Dispensing System

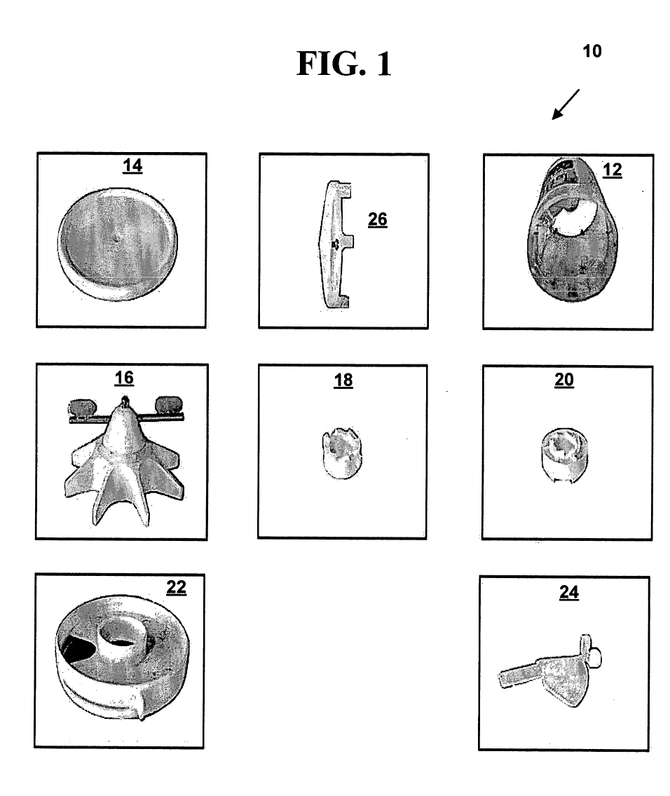

FIG. 1 is a block diagram illustrating a perspective view of components of a dispensing system 10.

In one embodiment, the dispensing system 10 includes, but is not limited to, a cylinder 12, an optional lid 14, doser/agitator 16, including two clutch gears, 18, 20, a base plate/dropper 22, a lever 24 and a freshness preserver plate 26. In another embodiment, the dispensing system 10 includes, but is not limited to, a cylinder 12, an optional lid 14, doser/agitator 16, a base plate/dropper 22, a lever 24 and a freshness preserver plate 26. However, the present invention is not limited to these embodiment or components and more fewer of other components can also be used to practice the invention.

The dispensing system 10 is described with respect to exemplary embodiments. The dispensing system 10 is used for dry goods (hereinafter “goods”). However, the present invention is not limited to these exemplary embodiments and other embodiment can also be used to practice the invention.

In one embodiment, the cylinder 12 comprises a clear or tinted (e.g., acting as an ultra-violet (UV) light inhibitor) plastic material with a grasping portion (e.g., a handle) to grasp the cylinder 12. The cylinder 12 may also comprise opaque plastic, metal, composite materials, wood or other materials. The grasping portion including handle comprises plastic, metal, composite materials, wood or other materials. However, the present invention is not limited to these materials and other materials can also be used to practice the invention.

In one embodiment of the invention, the cylinder 12 includes calibration markings allowing for precise and consistent dosing/metering/measuring of the dry goods contained therein. In such an embodiment, the calibration markings are permanently etched into a clear or tinted plastic material from which the cylinder 12 is comprised. However, the present invention is not limited to this embodiment and other types of calibration markings can also be used.

In one embodiment of the invention, the cylinder 12 includes a volume of 80 cups or 16 ounces of a good. In another embodiment, the cylinder 12 includes storage for a pre-determine number of cups, ounces, pounds, or grams of the goods. However the present invention is not limited to these embodiments and the cylinder 12 can comprise any desired volume using any desired measurement standard.

The optional lid 14 covers a top of cylinder 12. The lid 14 is removable to allow the cylinder 12 to be filled with a good. In one embodiment, the lid 14 snaps on the cylinder 12. In another embodiment, the lid 14 screws on the cylinder 12. The lid 14 includes a small hole in allow air to be moved into the cylinder 12 through the lid 14 when the freshness preserver plate 26 is moved down as goods are dispensed. The dispensing system 10 can be used without the optional lid 14. The optional lid 14 is optional provided and used for aesthetic purposes and for consumer confidence. However, the present invention is not limited to these embodiment and other types of lids 14 can be used to practice the invention. The lid 14 comprises plastic, composite materials, wood, metal, rubber or other material. However, the present invention is not limited to these materials and other materials can also be used to practice the invention.

The doser/agitator 16 is included within the cylinder 12 and makes direct contact with the goods temporarily stored within the cylinder 12. The doser/agitator 16, includes a bottom portion with plural fins for capturing and moving dry goods in ground, powder or granular form (e.g., for example, coffee, flour, spices, sugar, salt, laundry detergent, fertilizer, etc.) into the base plate/dropper 22. The plural fins are illustrated comprising an opaque plastic material. However, the plural fins can also comprise metal or other types of materials including clear plastic materials, composite materials, wood, metal, rubber or other materials. The present invention is not limited to these materials and other materials can also be used to practice the invention.

The doser/agitator 16 includes a top portion with plural arms (two of which are illustrated) that act within the goods to move the goods toward the bottom portion with plural fins. The plural arms are illustrated comprising a metal material and an opaque plastic material. However, the plural arms and the plural fins can also comprise other types of materials including clear plastic materials, composite materials, wood, metal, rubber or other materials. The present invention is not limited to these materials and other materials can also be used to practice the invention.

In one embodiment, the dispensing system 10 includes two clutch gears 18, 20 attached to the doser/agitator 16 and to the lever 24 via the base plate/dropper 22 to allow the lever 24 to activate the doser/agitator 16 and move goods from within the cylinder 12 out of the dispensing system 10 via an opening in the base plate/dropper 22. The invention is illustrated with two gears 18, 20 comprising an opaque plastic material. However, the invention is not limited to a dispensing system 10 with two gears and more or fewer gears can also be used to practice the invention. In addition, the two gears can comprise plastic, composite materials, metal, wood, rubber or other materials. The present invention is not limited to these materials and other materials can also be used to practice the invention.

The two clutch gears 18, 20 include plural teeth that precisely interlock the gears 18, 20 to each other and attach to the doser/agitator 16 and attach to a lever 24. The plural teeth of the two clutch gears are configured for accurately dispensing a pre-determined amount of the dry goods when the lever 24 is activated to engage the gears and move between a start position and a lever stop portion (or intermediate positions in between.)

In another embodiment, the dispensing system 10 does not include any clutch gears. In such an embodiment, the doser/agitator 16, the base plate/dropper 22 and the lever 24 are instead precisely configured for accurately dispensing a pre-determined amount of the dry goods when the lever 24 is activated to engage the doser/agitator 16 and move between a start position and the lever stop portion or intermediate positions in between. The present invention is not limited to these embodiments and other embodiments with and without clutch gears can be used to practice the invention.

The base plate/dropper 22 attaches to and is selectively removable from a bottom end of the cylinder 12. The base plate/dropper 22 helps creates an airtight seal in the cylinder 12 when attached and when its dispensing portions are closed. When its dispensing portions are open, the airtight seal is temporarily broken to dispense the goods. In one embodiment, base place/dropper 22 snaps on the cylinder 12. In another embodiment, the base plate/dropper 22 screws on the cylinder 12. However, the present invention is not limited to these embodiment and other types of base plates/droppers 22 can be used to practice the invention.

The base plate/dropper 22 includes a central upwardly protruding portion for attaching the doser/agitator 16 within. The base plate/dropper 22 also includes plural dispensing portions to dispense goods from the dispensing system 10. The base plate/dropper 22 also includes a slot to engage the lever 24, and a protruding lever stop portion for preventing the lever from moving past the lever stop portion.

In one embodiment, the base plate/dropper 22 is illustrated comprising an opaque plastic material. However, the plural fins can also comprise, clear plastic materials composite materials, metal, wood or other types of materials. The present invention is not limited to these materials and other materials can also be used to practice the invention.

The lever 24 is used to activate and control the doser/agitator 16 via the gears 18, 20 and/or directly active and control the doser/agitator 16 without using any gears. The lever 24 allows goods to be dispensed from the dispensing system 10 by selectively uncovering and covering (i.e., opening and closing) the dispensing portions in the base/plate dropper 16. The lever 24 in combination with the two clutch gears 18, 20, the doser/agitator 16 and the base plate/dropper 22 or directly with doser/agitator 16 and the base plate/dropper 22 when clutch gears are not used, is used to accurately and precisely dosing/metering/dispensing a specific measure amount of the goods contained within the cylinder 12 during activation. The lever 24 is used to accurately and precisely dose/meter/dispense a desired amount of the goods contained in the cylinder 12 including a desired amount measured in cups, ounces, pounds, grams, or virtually any desired measurement system amount.

The freshness preserver plate 26 includes a bottom portion that is cone shaped with plural angled walls (i.e., acute angles) to engage the goods and remain in complete contact (i.e., bottom surface) with the top layer of the goods towards the bottom of the cylinder 12 for dispensing. The cone shape creates a funneling affect that helps collapse the goods towards the inner walls of the cylinder 12 with the help of gravity and aids movement by the doser/agitator 16 to maintain an even top surface of the goods. The freshness preserver plate 26 further includes plural tabs (three of which are illustrated) with rounded top surfaces to stabilize the plate to stay at a right angle (i.e. 90 degrees) in relation to the cylinder 12 at all times.

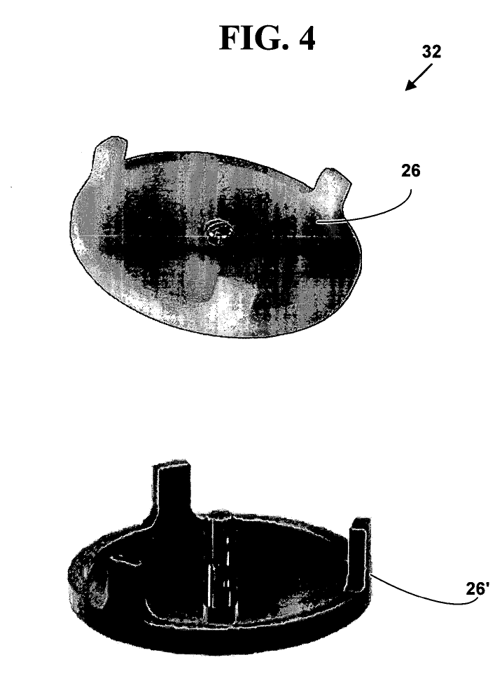

The freshness preserver plate 26 further includes a grasping portion (presently illustrated with a stainless steel screw 26 and a plastic tab 26′ of FIG. 4) to grasp the vacuum plate 26 for removal. In a one embodiment of the invention, the grasping portion includes a plastic grasping portion that connects all of the plural tabs for easy grasping (not illustrated). However, the present invention is not limited to these embodiments and other grasping portions can also be used to practice the invention. However the grasping portion of the freshness preserver plate 26 can include clear plastic materials composite materials, metal, wood or other types of materials. The present invention is not limited to these materials and other materials can also be used to practice the invention.

The freshness preserver plate 26 is precisely manufactured and includes special surface and edge geometry to assure a smooth, consistent downward movement in the cylinder 12. During its downward movement in the cylinder 12, the freshness preserver plate 26 continually wipes off any residual of the goods on the sidewalls of cylinder 12 and flattens a top surface of the goods while maintaining an airtight seal within the cylinder 12. The rounded surfaces on top of the plural tabs allow for easy removal (e.g., for cleaning, loading, etc.) without cocking or tipping the freshness preserver plate 26 in the cylinder 12. That is, without rocking the freshness preserver plate 26 back and forth.

The freshness preserver plate 26 is included within the cylinder 12 and makes direct contact with the goods temporarily stored within the cylinder 12. Goods are added to the cylinder 12 by removing the optional lid 14, inserting the goods, placing the freshness preserver plate 26 on top of the goods and replacing the lid 14 to create an airtight seal. Downward movement of the freshness preserver plate 26 as goods are dispensed from the bottom of the cylinder 12 creates an airtight seal within the cylinder 12.

The freshness preserver plate 26 closely follows the goods and after one or more dispensing cycles the top layer of the goods evens itself out and the cone shaped design of the bottom portion of the freshness preserver plate 26 comes in direct contact with the goods along its entire surface, hence eliminating almost all “head space” (i.e., air space) in the cylinder 12 between the freshness preserver plate 26 and goods. The elimination of the head space helps keeps the goods fresher when temporarily stored within the cylinder 12.

Once the goods are added to the top of the cylinder 12, the freshness preserver plate 26 helps ensure the goods will not come in contact with air or moisture again until they are dispensed from the dispensing system 10. Thus, the freshness preserver plate 26 helps to preserve and enhance freshness of the goods stored temporarily therein. This flattening action also works well in conjunction with the doser/agitator 16 that moves around whenever the lever 24 for dispensing is activated and controlled.

The freshness preserver plate 26 in part allows the dispensing system 10 to be opened only once at the time of filling and stays closed until all goods contained therein are dispensed. In essence, the total volume of air entering the cylinder 12 during a dispensing period is equal to a total volume of goods dispensed during one total fill of the cylinder 12. However, the volume of air entering the cylinder 12 has minimal contact with the goods contained therein due to the freshness preserver plate which allows air to enter only above the freshness preserver plate 26.

Assuming that freshness loss of goods contained therein is due to an oxidation process, the introduction of “fresh” oxygen back into the cylinder 12 is minimal during the entirety of the dispensing process. Since the freshness preserver plate 26 creates and airtight seal within the cylinder 12, air can only enter the cylinder 12 through the base plate/dropper 22 and this is minimal due to the goods themselves blocking air movement back into the cylinder 12 as a portion of the goods are dispensed.

The freshness preserver plate 26 is illustrated as being circular in shape with a cone shaped bottom. However, the present invention is not limited to these shapes and other shapes and other configurations can also be used to for the freshness preserver plate 26 to practice the invention.

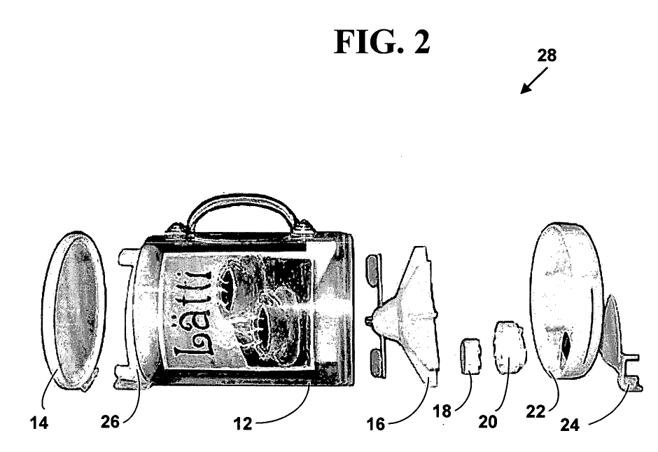

FIG. 2 is a block diagram 28 illustrating an exploded view of the dispensing system of FIG. 1.

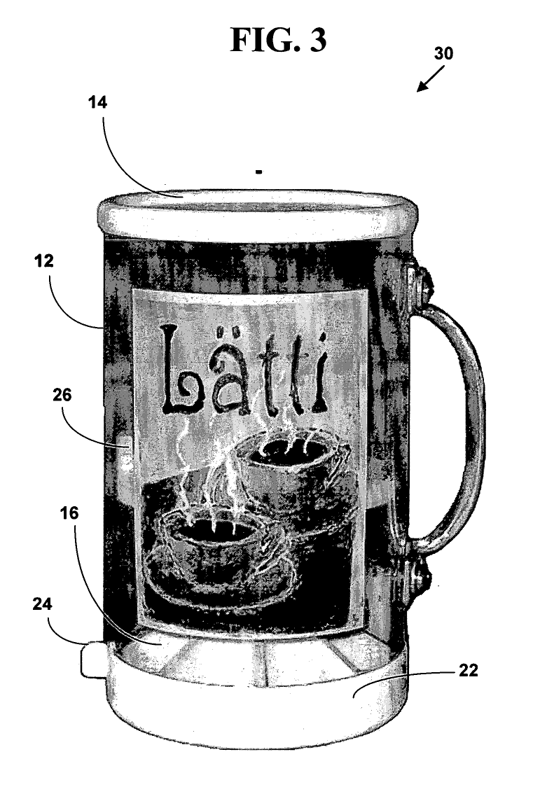

FIG. 3 is a block diagram 30 illustrating a side view of the dispensing system of FIG. 1.

FIG. 4 is a block diagram 32 illustrating a top view of a freshness preserver plate 26 of the dispensing system of FIG. 1.

Exemplary Method of Use

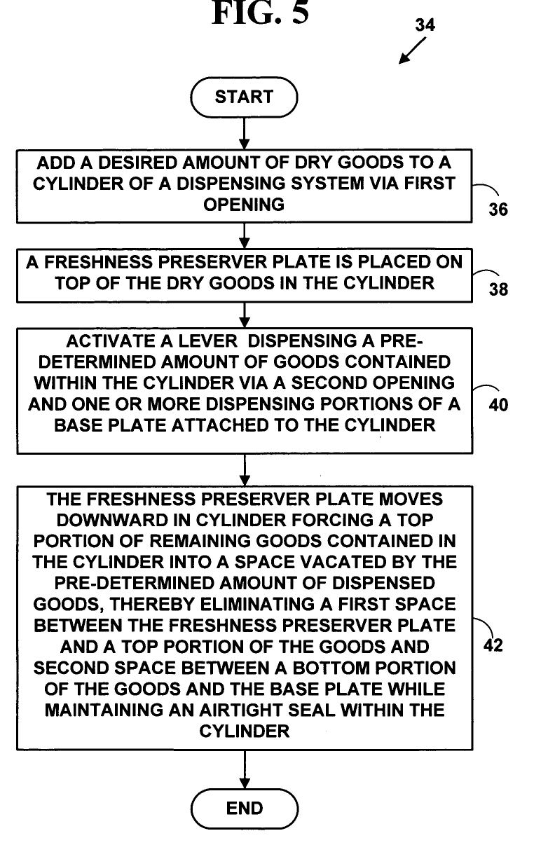

FIG. 5 is a flow diagram illustrating a Method 34 of use of the dispensing system 10. At Step 36, a desired amount of dry goods are added to cylinder 12 via the first opening. At Step 38, the freshness preserver plate 26 is placed on top of the dry goods. At Step 40, the lever 24 is activated dispensing a pre-determined amount of goods contained within the cylinder 12 via the second opening and the one or more dispensing potions of the base plate 22. At Step 42, the freshness preserver plate 26 moves downward in the cylinder 12 forcing a top portion of remaining goods contained in the cylinder 12 into a space vacated by the pre-determined amount of dispensed goods, thereby eliminating a first space between freshness preserver plate 26 and a top portion of the goods and second space between a bottom portion of the goods and the base plate 22 while maintaining an airtight seal within the cylinder 12.

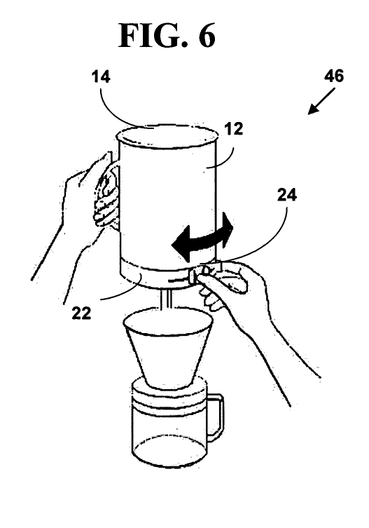

FIG. 6 is a block diagram 46 visually illustrating use of the dispensing system 10.

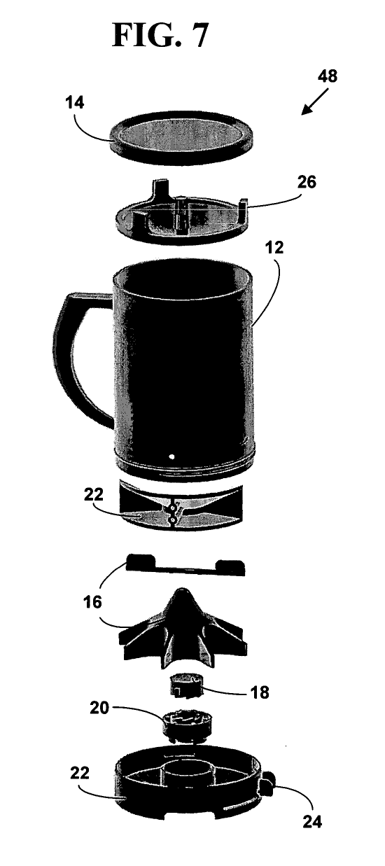

FIG. 7 is a block diagram 48 illustrating another exploded view of the dispensing system.

The dispensing system 10 and method may offer at least the following advantages: (1) preserve the freshness of goods via the freshness preserver plate 26 since there is minimal interaction between the goods and air; (2) preserve the freshness of goods via the freshness preserver plate 26 due to moisture barrier for the goods; (3) the freshness preserver plate 26 in combination with the doser/agitator 16 eliminates the need for an internal funneling system; (4) provides precise and consistent dosing/metering; and (5) is suitable for virtually every type of dry goods in ground, powder or granular form (e.g., For example, coffee, flour, spices, sugar, salt, laundry detergent, fertilizer, etc).

It should be understood that the components, programs, processes, methods described herein are exemplary only. It should be understood that the architecture, programs, processes, methods and systems described herein are not related or limited to any particular type of components or materials, unless indicated otherwise. Various types of general purpose or specialized components or materials may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented with certain components and materials, in other embodiments other implementations and/or combinations or components and materials may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

1. A dispensing system for dispensing dry goods, comprising in combination:
a cylinder with a first opening for receiving dry goods and a second opening for dispensing the dry goods;
an optional lid for covering the first opening of the cylinder and removeably attached thereto, for covering the first opening and for allowing dry goods to be put into the cylinder via the first opening;
a freshness preserver plate provided within the cylinder placed on top of the dry goods added to the cylinder, including a cone shaped bottom portion to engage the dry goods, to collapse the dry goods around the cone shape and force the dry goods towards the bottom of the cylinder for dispensing the dry goods, for moving downward within the cylinder as the dry goods are dispensed while maintaining an airtight seal within the cylinder and including a top portion with a plurality of tabs with a plurality of rounded edges for engaging the cylinder at right angles to stabilize the freshness preserver plate in the cylinder and maintain the airtight seal as the dry goods are dispensed;
an agitator provided within the cylinder and attached to a base plate, including a bottom portion with a plurality of fins for capturing and moving goods into the base plate and a top portion with a plurality of arms that act within the dry goods to move the dry goods towards the base plate via the plurality of fins;
a base plate for covering the second opening of the cylinder removably attached thereto, for creating airtight seal over the second opening of the cylinder, including a raised central portion for attaching to the agitator, one or more dispensing portions to dispense dry goods via the second opening selectively covered and uncovered by a lever, one or more gears connected to the lever to accurately dispense a desired portion of the dry goods, a slot to engage the lever for accurately dispensing a pre-determined amount of the dry goods, and a protruding lever stop portion for preventing the lever from moving past the lever stop portion; and
a lever attached to and protruding from the base plate for activating and controlling the agitator via the one or more gears and allowing dry goods to be dispensed through the second opening of the cylinder via the one or more dispensing portions in the base plate by selectively covering and uncovering the dispensing portions in the base plate.

2. The dispensing system of claim 1 wherein the cylinder includes calibration markings permanently etched thereon allowing for precise and consistent dosing, metering or measuring of the dry goods contained therein.

3. The dispensing system of claim 1 wherein the cylinder further includes a grasping portion for grasping the dispensing system.

4. The dispensing system of claim 1 wherein the cylinder includes storage for a pre-determine number of cups, ounces, pounds or grams of the dry goods.

5. The dispensing system of claim 1 wherein the dry goods include coffee, flour, spices, sugar, salt, laundry detergent, fertilizer, or other dry goods in ground, powder or granular form.

6. The dispensing system of claim 1 wherein the cylinder comprises a clear plastic, opaque plastic, metal, composite, rubber or wood material.

7. The dispensing system of claim 1 wherein the freshness preserver plate wipes off any residual of the dry goods on the sidewalls of the cylinder and continually collapses and then flattens a top surface of the dry goods as a bottom surface of the dry goods are dispensed through the second opening of the cylinder.

8. The dispensing system of claim 1 the freshness preserver plate helps to preserve and enhance freshness of the goods stored temporarily in the cylinder by maintaining an airtight seal within the cylinder and limit contact of the dry goods with air outside the cylinder.

9. The dispensing system of claim 1 wherein the freshness preserver plate further includes a grasping means to grasp the freshness preserver plate for easy removal from the cylinder.

10. The dispensing system of claim 1 wherein the freshness preserver plate comprises a plastic, metal, composite, rubber, or wood material.

11. The dispensing system of claim 1 wherein the plurality of tabs with rounded top surfaces on the top portion of the freshness preserver plate allow the freshness preserver plate to be removed from the cylinder without tipping the freshness preserver plate in the cylinder.

12. The dispensing system of claim 1 wherein the agitator includes a bottom portion with a plurality of plastic fins and a top portion with a plurality of metal arms.

13. The dispensing system of claim 1 wherein the base plate includes two clutch gears with a plurality of teeth attached to and interlocked with each other, attached to the agitator and attached to the lever, wherein the plurality of teeth are configured for accurately dispensing a pre-determined amount of the dry goods when the lever is activated between a start position and the lever stop portion or intermediate positions in between.

14. The dispensing system of claim 1 wherein the lever includes markings for precise and consistent dispensing of the dry goods contained in the cylinder.

15. A dispensing system for dispensing dry goods, comprising in combination:
a storage means with a first opening for receiving dry goods and a second opening for dispensing the dry goods;
an optional cover means for covering the first opening of the container and for allowing dry goods to be placed into the container;
an airtight means provided within storage means with a cone shaped bottom portion to engage the dry goods, collapse the dry goods around the cone and force the dry goods towards the bottom of the storage means for dispensing while maintaining an airtight seal within the storage means and a top portion with a plurality of rounded tabs for engaging the storage means at a right angle to stabilize the freshness preserver plate means in the storage means and maintain the airtight seal as the dry goods are dispensed;
dispensing means provided within the storage means attached to a base means including a bottom portion with a plurality of fins for capturing and moving goods into the base means and a top portion with a plurality of arms that act within the dry goods to move the dry goods toward the second opening of the storage means via the plurality of fins;
base means for covering the second opening of the storage means and for creating airtight seal over the second opening with a raised central portion for attaching dispensing means, one or more dispensing portions to dispense dry goods via the second opening, one or more gears connected to an activating means to accurately dispense a desired portion of the dry goods, a slot to engage the activating means for accurately dispensing a predetermined amount of the dry goods, and a protruding activating means stop portion for preventing the activating means from moving past the activating means stop portion; and
an activating means for activating and controlling the base means via the one or more gears and allowing dry goods to be dispensed through the second opening via the one or more dispensing portions in the base means.

16. A dispensing system for dispensing coffee, comprising in combination:
a storage means with a first opening for receiving coffee and a second opening for dispensing the coffee;
an airtight means provided within storage means with a cone shaped bottom portion to engage the coffee, collapse the coffee around the cone and force the coffee towards the bottom of the storage means for dispensing while maintaining an airtight seal within the storage means and a top portion with a plurality of rounded tabs for engaging the storage means at a right angle to stabilize the airtight means in the storage means and maintain the airtight seal as the coffee are dispensed;
dispensing means provided within the storage means attached to an activating means including a bottom portion with a plurality of fins for capturing and moving goods into a base means and a top portion with a plurality of arms that act within the coffee to move the coffee toward the second opening of the storage means via the plurality of fins;
a base means for covering the second opening, dispensing the coffee and for engaging an activating means; and
an activating means for activating and controlling the dispensing means allowing coffee to be dispensed through the second opening via the base means.

17. The dispensing system of claim 16 wherein the airtight means wipes off any residual of the coffee on the sidewalls of the storage means and continually collapses and then flattens a top surface of the coffee as a bottom surface of the coffee are dispensed through the second opening of the storage means.

18. The dispensing system of claim 16 the airtight means helps to preserve and enhance freshness of the coffee stored temporarily in the storage means by maintaining an airtight seal within the storage means and limited contact of the coffee with air outside the storage means.

19. The dispensing system of claim 16 wherein the airtight means further includes a grasping means to grasp the airtight means.

20. The dispensing system of claim 16 wherein the plurality of tabs include a plurality of rounded top surfaces on the top portion of the airtight means to allow the airtight means to be removed from the storage means without tipping the airtight means in the storage means.
